(19) United States
(12) Patent Application Publication
(10) Pub. No.: US 2006/0176011 A1
(43) Pub. Date: Aug. 10, 2006

(54) Battery charger with polarity switching capability

(75) Inventor: Chao-Chih Liu, Taichung (TW)

Correspondence Address: MERCHANT & GOULD PC, P.O. BOX 2903, MINNEAPOLIS, MN, 55402-0903, US

(73) Assignee: JUYE LII INTERNATIONAL CO., LTD., Taichung (TW)

(21) Appl. No.: 11/052,365

(22) Filed: Feb. 7, 2005

(51) Int. Cl. H02J 7/00

(52) U.S. Cl. 320/105

(57) ABSTRACT

A charger includes a conducting member having a first end connected electrically to one of first and second contact plates on one of first and second clampers, and an opposite second end connected electrically to a charging circuit. The conducting member permits transmission of a reset signal to the charging circuit such that a switch controller of the charging circuit enables power to be sent from a power source unit to a battery through a selected pair of a first direction unit and a first switch, and a second direction unit and a second switch according to polarity connections of the first and second clampers to positive and negative electrodes of the battery when the first and second clampers clamp positive and negative electrodes of the battery.

### BACKGROUND OF THE INVENTION

1. Field of the Invention

The invention relates to a battery charger, more particularly to a battery charger with a polarity switching capability.

2. Description of the Related Art

A conventional battery charger is not equipped with a polarity switching capability. Hence, when the conventional battery charger is operated in the dark, sparks or explosion may occur as a result of wrong polarity connection.

To overcome the aforesaid drawback, U.S. Pat. No. 6,130,519 discloses a portable battery charger including an auto-polarity switch, whereas U.S. Pat. No. 6,759,833 discloses a charger capable of switching polarity.

Referring to FIG. 1, a battery booster apparatus 7 disclosed in U.S. Pat. No. 6,130,519 includes an auto-polarity switch 73 that ensures a proper polarity connection between a battery 71 and an electrical system to be-charged, and a normally opened ON/OFF switch 74 located between the battery 71 and the auto-polarity switch 73.

Referring to FIGS. 2 and 3, a charger 8 capable of switching polarity disclosed in U.S. Pat. No. 6,759,833 includes are set switch 81 mounted on a housing 80 and connected between first and second switches 82, 83 and an abundant battery 84. The reset switch 81 is operable so as to enable removal of residual magnetism in the charger 8.

Furthermore, referring to FIG. 4, there is shown a conventional charger clamper 9 that includes opposite clamping arms, each of which is provided with a contact plate 91 thereon. Since the contact plates 91 on the clamping arms contact each other, contact sparks occur at the time an electrode of an electrical apparatus to be charged is clamped while the charger (not shown) is in a powered state.

### SUMMARY OF THE INVENTION

Therefore, the object of the present invention is to provide a battery charger with a polarity switching capability that can eliminate the aforesaid drawbacks of the prior art.

According to the present invention, there is provided a charger for charging a battery that has positive and negative electrodes. The charger comprises:

a power source unit for providing electric power;

a charging circuit including
a first direction unit coupled to the power source unit,
a second direction unit coupled to the power source unit,
a first switch coupled to the first direction unit;,
a second switch coupled to the second direction unit, and
a switch controller coupled to the first and second direction units, and the first and second switches;

a first clamper including opposite first clamping arms spaced apart from each other, each of the first clamping arms having a first clamping end provided with a first contact plate thereon, the first damper being adapted for connecting electrically the charging circuit to the battery when the first camper clamps one of the positive and negative electrodes of the battery;

a second damper including opposite second clamping arms spaced apart from each other, each of the second clamping arms having a second clamping end provided with a second contact plate thereon, the second clamper being adapted for connecting electrically the charging circuit to the battery when the second damper clamps the other of the positive and negative electrodes of the battery; and

a conducting member having a first end connected electrically to one of the first and second contact plates on one of the first and second clampers, and an opposite second end connected electrically to the charging circuit.

The switch controller enables power to be sent from the power source unit to the battery through a selected pair of the first direction unit and the first switch, and the second direction unit and the second switch according to polarity connections of the first and second clampers to the positive and negative electrodes of the battery.

The conducting member permits transmission of a reset signal to the charging circuit to enable sending of power from the power source unit to the battery when the first and second clampers clamp the positive and negative electrodes of the battery.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic electrical circuit diagram of a conventional battery charger;

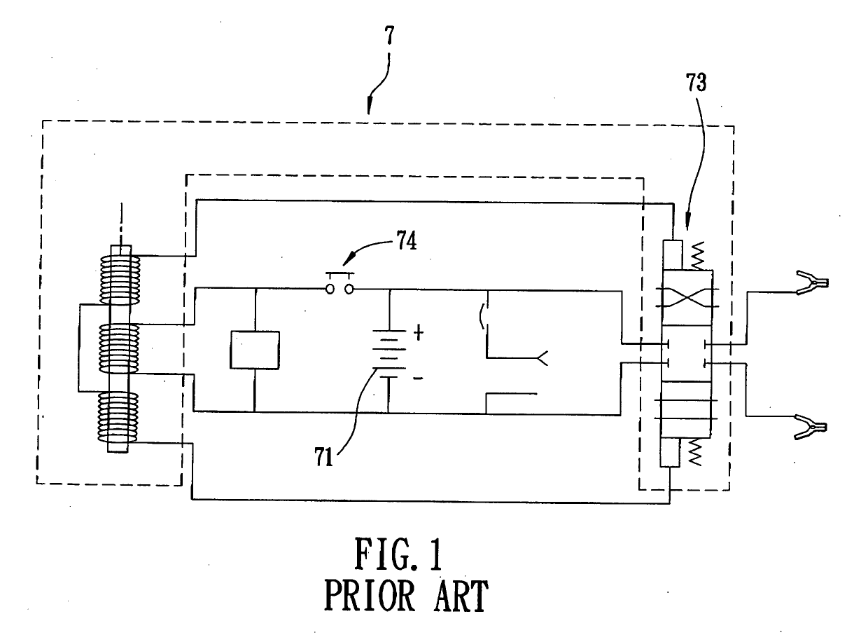

FIG. 2 is a schematic electrical circuit diagram of another conventional battery charger;

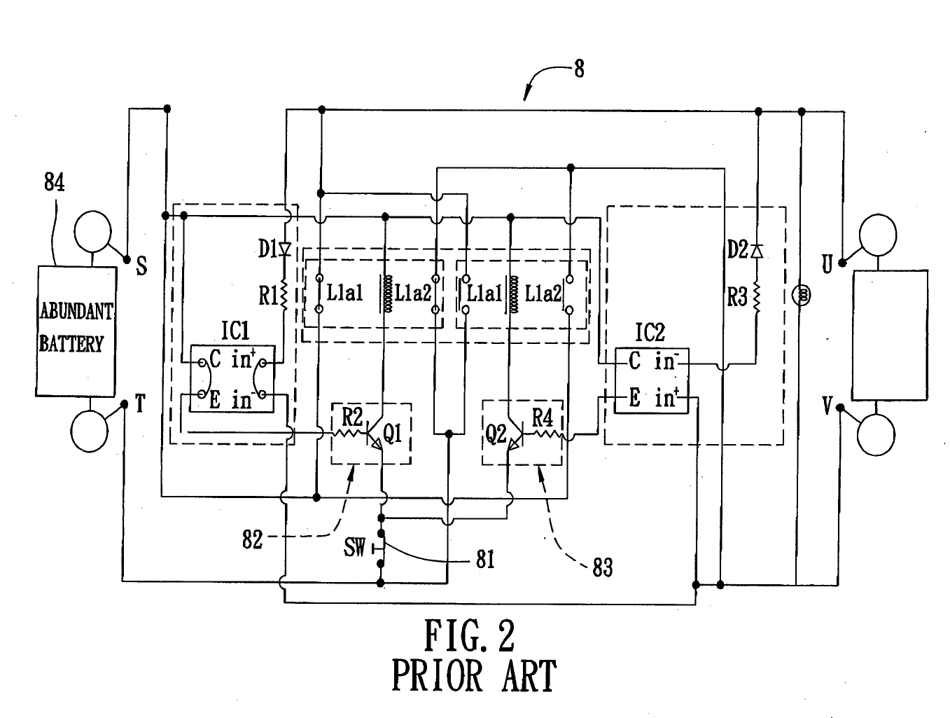

FIG. 3 is a schematic view of a further conventional battery charger;

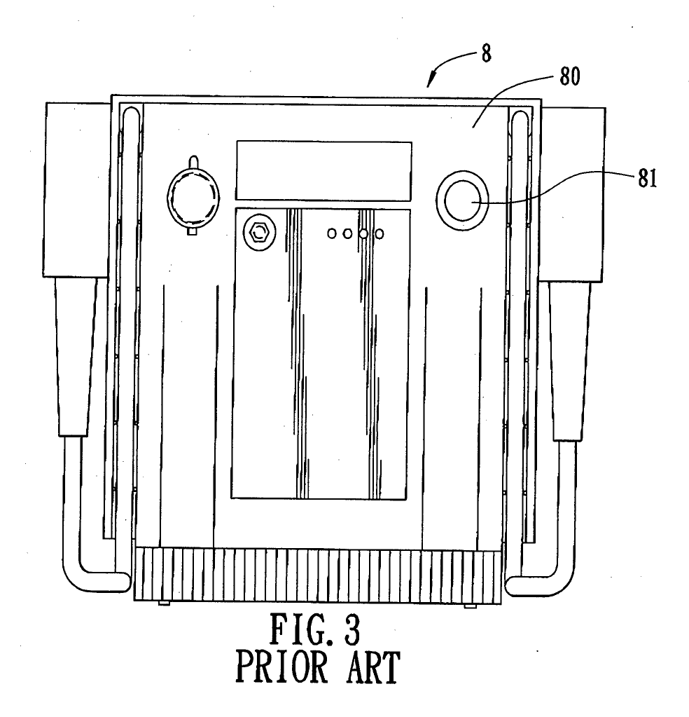

FIG. 4 is a partly sectional schematic view of a conventional clamper;

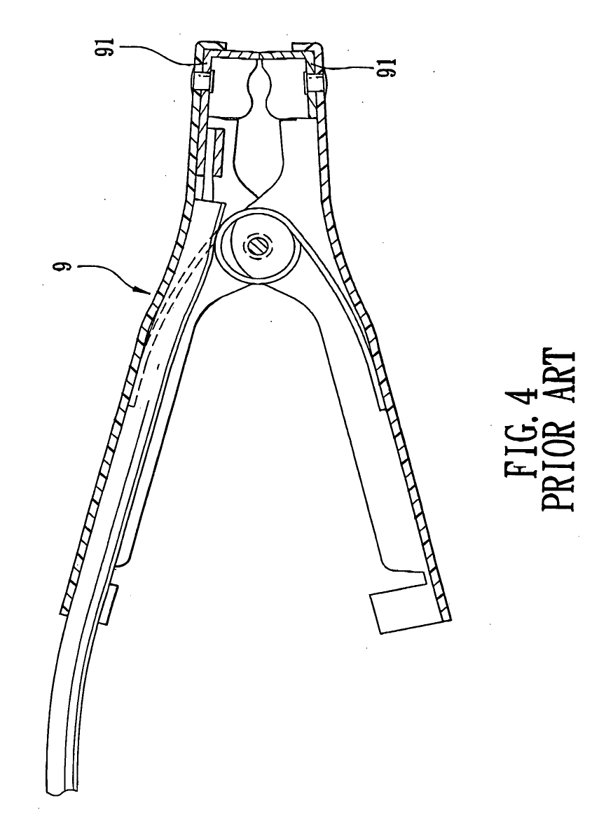

FIG. 5 is a schematic front view showing the preferred embodiment of a battery charger according to this invention;

FIG. 6 is a schematic rear view showing the preferred embodiment;

FIG. 7 is a schematic circuit block diagram illustrating the preferred embodiment of a battery charger according to this invention;

FIG. 8 is a schematic circuit block diagram illustrating a charging circuit of the preferred embodiment;

FIG. 9 is a partly sectional schematic view showing a first clamper of the preferred embodiment; and

FIG. 10 is a partly sectional schematic view showing a second clamper of the preferred embodiment.

### DETAILED DESCRIPTION OF THE PREFERRED EMBODIMENT

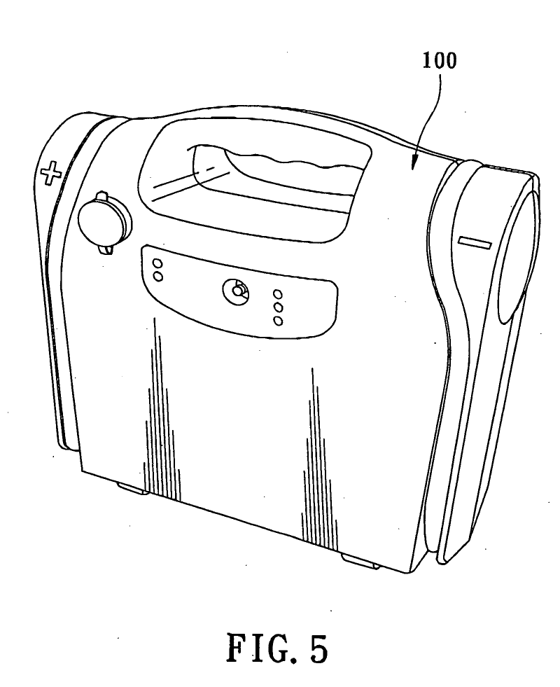

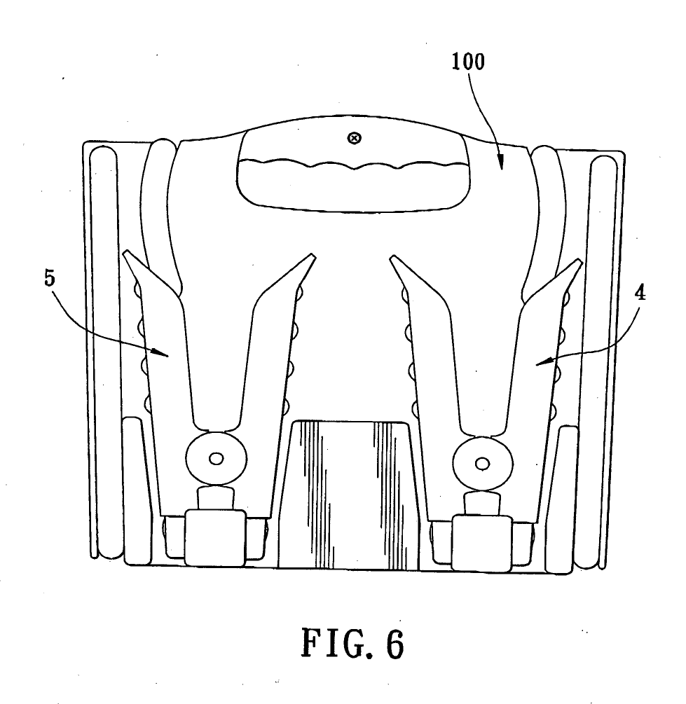

Referring to FIGS. 5 to 7, the preferred embodiment of a charger for charging a battery 200 according to the present invention is shown to include a housing 100, a power source unit 1, a charging circuit 2, a first damper 4, a second damper 5, and a conducting member 6. The battery 200 has positive and negative electrodes 201, 202.

The power source unit 1, such as an abundant battery, is mounted in the housing 100 for providing electric power.

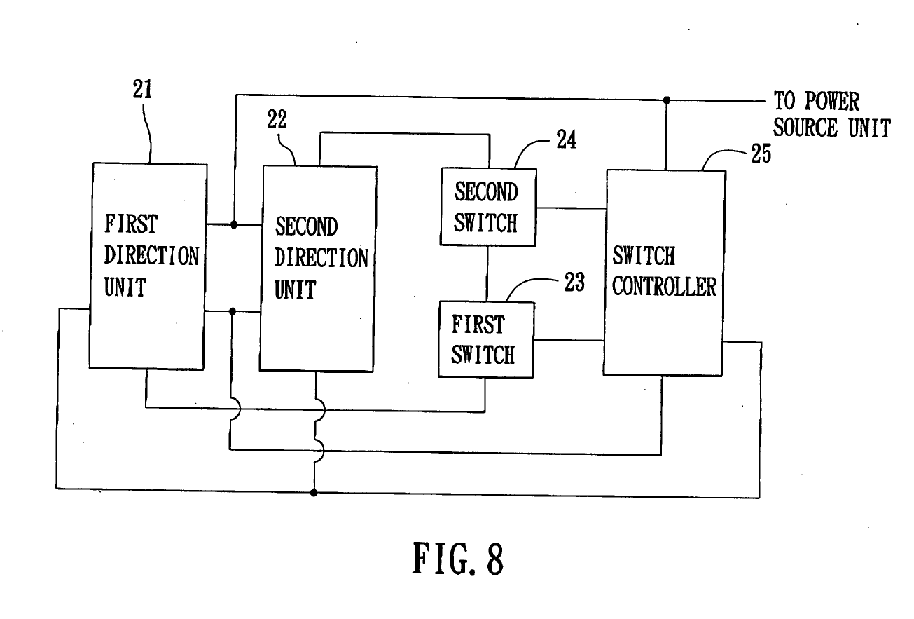

The charging circuit 2 is mounted in the housing 100. As shown in FIG. 8., the charging circuit 2 includes a first direction unit 21 coupled to the power source unit 1, a second direction unit 22 coupled to the power source unit 1, a first switch 23 coupled to the first direction unit 21, a second switch 24 coupled to the second direction unit 22, and a switch controller 25 coupled to the first and second direction units 21, 22 and the first and second switches 23, 24.

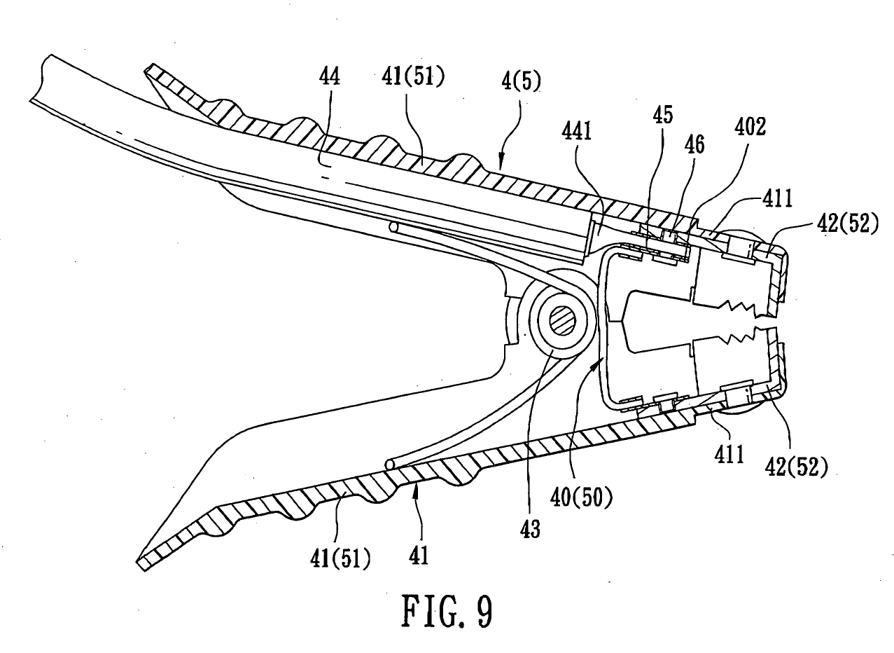

As shown in FIG. 9, the first damper 4 includes opposite first clamping arms 41 spaced apart from each other and interconnected by means of a torsion spring 43. Each of the first clamping arms 41 has a first clamping end 411 provided with a first contact plate 42 thereon. The first damper 4 is adapted for connecting electrically the charging circuit 2 to the battery 200 when the first damper 4 clamps one of the positive and negative electrodes 201, 202 of the battery 200. In this embodiment, the first clamper 4 is disposed outside of the housing 100, and is connected to the charging circuit 2 by means of an electric wire 44, wherein one end 441 of the electric wire 44 is connected electrically to the first contact plate 42 on one of the first clamping arms 41 by means of a pair of conductive locking pieces 45 and a screw fastener 46. In this embodiment, the first damper 4 further includes a conducting wire 40 interconnecting electrically the first contact plates 42 on the first clamping arms 41.

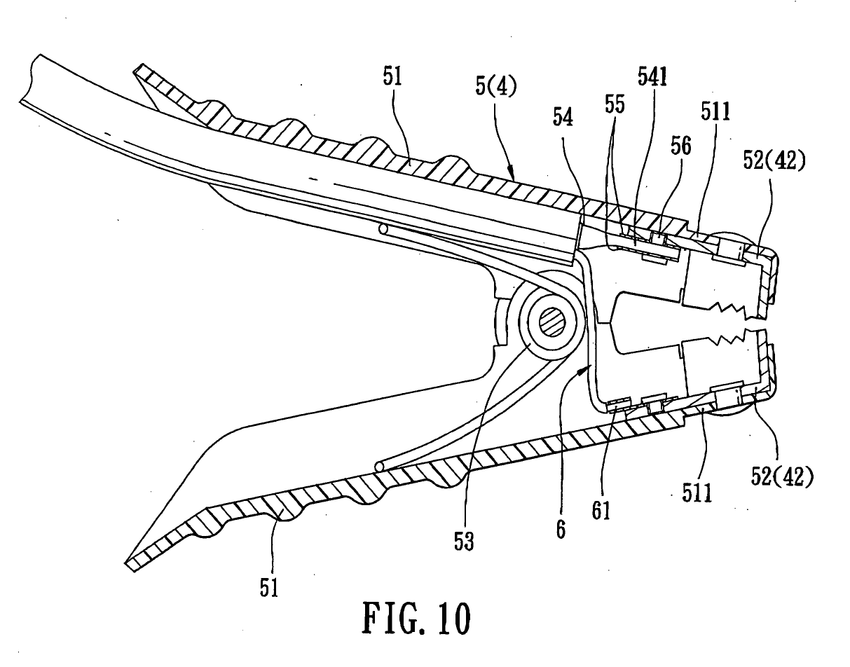

As shown in FIG. 10, the second damper 5 includes opposite second clamping arms 51 spaced apart from each other and interconnected by means of a torsion spring 53. Each of the second clamping arms SI has a second clamping end 511 provided with a second contact plate 52 thereon. The second damper 5 is adapted for connecting electrically the charging circuit 2 to the battery 200 when the second damper 5 clamps the other one of the positive and negative electrodes 201, 202 of the battery 200. In this embodiment, the second damper 4 is disposed outside of the housing 100, and is connected to the charging circuit 2 by means of an electric wire 54, wherein one end 541 of the electric wire 54 is connected electrically to the second contact plate 52 on one of the second clamping arms 51 by means of a pair of conductive locking pieces 55 and a screw fastener 56.

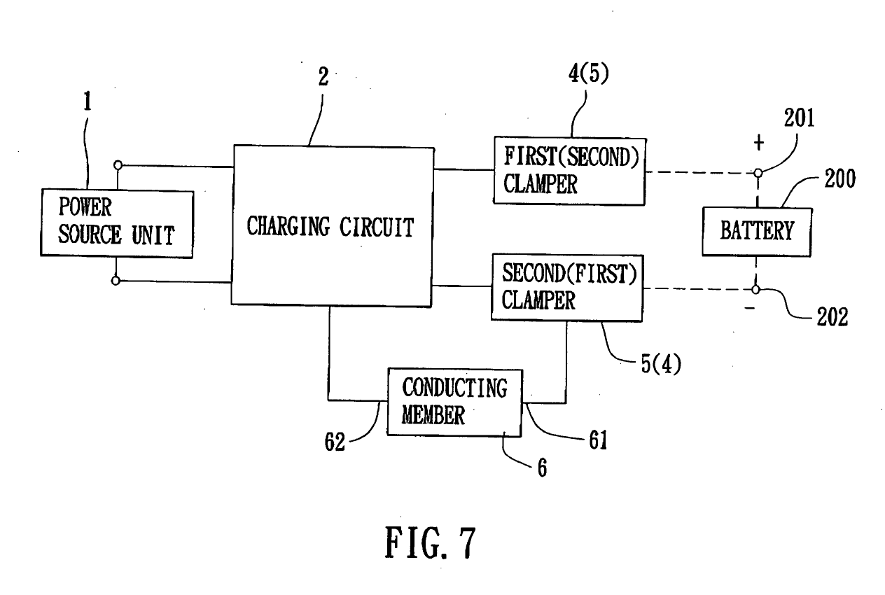

The conducting member 6 has a first end 61 connected electrically to the second contact plate 52 on the other one of the second clamping arms 51 of the second damper 5, as shown in FIG. 10, and opposite second end 62 connected electrically to the charging circuit 2 (see FIG. 7).

The switch controller 25 enables power to be sent from the power source unit 1 to the battery 200 through a selected pair of the first direction unit 21 and the first switch 23, and the second direction unit 22 and the second switch 24 according to polarity connections of the first and second dampers 4, 5 to the positive and negative electrodes 4, S of the battery 200.

The charging circuit 2 employed in this embodiment is based on that disclosed in U.S. Pat. No. 6,759,633. Hence, one may refer to said patent for additional details on the construction and operation of the charging circuit 2.

Furthermore, the conducting member 6 permits transmission of a reset signal to the charging circuit 2 to enable sending of power from the power source unit 1 to the battery 200 when the first and second clampers 4, 5 clamp the positive and negative electrodes 201, 202 of the battery-200.

It is noted that the first end 61 of the conducting member 6 is not limited to be connected electrically to the second clamper 5. In other embodiments, the first end 61 of the conducting member 6 can be connected electrically to the first contact plate 42 on the other one of the first clamping arms 41 of the first clamper 4, as indicated by numerals in parentheses of FIG. 10. In this case, the second clamper 5 further includes a conducting wire 50 interconnecting electrically the 20 second contact plates 52 on the second clamping arms 51, as indicated by numerals in parentheses of FIG. 9.

The following are some of the advantages attributed to the charger of the present invention:

1. Due to the presence of the conducting member 6, the reset signal can be transmitted to the charging circuit 2 to enable sending of power from the power source unit 1 to the battery 200 when the first and second clampers 4, 5 clamp the positive and negative electrodes 201, 202 of the battery without the need for operating a switch, thereby resulting in convenience.

2. Since the first contact plates 42 on the first damper 4 are spaced apart from each other, and since the second contact plates 52 on the second clamper 5 are spaced apart from each other, contact sparks at a moment of powering the charger can be avoided.

3. Due to the presence of the conducting wire 40 (50), contact sparks at a moment of clamping can be avoided. While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A charger for charging a battery that has positive and negative electrodes, said charger comprising:
a power source unit for providing electric power;
a charging circuit including
a first direction unit coupled to said power source unit,
a second direction unit coupled to said power source unit,
a first switch coupled to said first direction unit,
a second switch coupled to said second direction unit, and
a switch controller coupled to said first and second direction units, and said first and second switches;
a first damper including opposite first clamping arms spaced apart from each other, each of said first clamping arms having a first clamping end provided with a first contact plate thereon, said first clamper being adapted for connecting electrically said charging circuit to the battery when said first damper clamps one of the positive and negative electrodes of the battery;
a second clamper including opposite second clamping arms spaced apart from each other, each of said second clamping arms having a second clamping end provided with
a second contact plate thereon, said second clamper being adapted for connecting electrically said charging circuit to the battery when said second clamper clamps the other of the positive and negative electrodes of the battery; and
a conducting member having a first end connected electrically to one of said first and second contact plates on one of said first and second clampers, and an opposite second end connected electrically to said charging circuit;
wherein said switch controller enables power to be sent from said power source unit to the battery through a selected pair of said first direction unit and said first switch, and said second direction unit and said second switch according to polarity connections of said first and second dampers to the positive and negative electrodes of the battery;
wherein said conducting member permits transmission of a reset signal to said charging circuit to enable sending of power from said power source unit to the battery when said first and second clampers clamp the positive and negative electrodes of the battery.

2. The charger as claimed in claim 1, wherein said first clamper further includes a conducting wire interconnecting electrically said first contact plates on said first clamping arms when said first end of said conducting member is connected electrically to said second clamper.

3. The charger as claimed in claim 1, wherein said second damper further includes a conducting wire interconnecting electrically said second contacting plates on said second clamping arms when said first end of said conducting member is connected electrically to said first clamper.
